(19) United States
(12) Patent Application Publication
(10) Pub. No.: US 2026/0326390 A1
(43) Pub. Date: Oct. 22, 2026

(54) Method for connecting fiber composite material to a metal surface, and fiber composite material laying device

(71) Applicant: Technische Universität Braunschweig, Braunschweig (DE)

(72) Inventors: Mohammad BAHAR, Vechelde (DE); Bernd FELDHAUS, Braunschweig (DE); Yaser ZYADA, Braunschweig (DE)

(21) Appl. No.: 19/544,337

(22) Filed: Feb. 19, 2026

Related U.S. Application Data
(63) Continuation-in-part of application No. PCT/EP2024/073092, filed on Aug. 16, 2024.

(30) Foreign Application Priority Data
Sep. 4, 2023 (DE) 10 2023 123 731.4

(51) Int. Cl. B29C 65/44; B23K 26/352; B29C 65/00

(52) U.S. Cl. CPC B29C 65/44; B23K 26/355; B29C 66/028; B29C 66/45; B29C 66/721; B29C 66/742

(57) ABSTRACT

A method for connecting a fiber composite material to a metal surface of a component includes formation of a micro-structure with a plurality of micro-recesses in the metal surface. Micro-structure formation can be accomplished with a laser beam directed at the metal surface at two different incidence angles. The fiber composite material has a planar textile and a matrix that is made of a matrix material which embeds the planar textile. The fiber composite material is joined to the metal surface by exerting a consolidation force (F_{K}), directed towards the metal surface, onto the fiber composite material. An (an oscillating shear force is applied to the fiber composite material, causing the matrix material to be introduced into the micro-recesses of the metal surface.

### CROSS-REFERENCE TO RELATED APPLICATIONS

This application is a continuation-in-part (CIP) application of International Application PCT/EP 2024/073092 filed Aug. 16, 2024 which claims priority to German Application 10 2023 123 731.4 filed Sep. 4, 2023.

### FIELD OF THE INVENTION

The invention relates to a method for connecting a fiber composite material to a metal surface of a component, comprising the steps (a) applying the fiber composite material, which has a planar textile and a matrix that is made of a matrix material and embeds the textile, to the metal surface, and (b) exerting a consolidation force, directed towards the metal surface, onto the fiber composite material. According to a second aspect, the invention relates to a fiber composite material laying device.

### BACKGROUND

The combination of metal components and fiber composite material has a number of advantages as it allows the beneficial properties of metal and fiber composite material to be combined. For example, the fiber composite materials combine the tensile strength of fiber composites with the toughness of metallic materials.

However, connecting fiber composite materials to a metal component has proven to be problematic.

It is known to apply fiber composite materials to metal surfaces. The disadvantage of this is that it results in three boundary layers, namely from the metal surface to the adhesive and from the adhesive to the fiber composite material. Such boundary layers can be defective and thus reduce the strength of the connection. It is also difficult to test the boundary layers in a non-destructive manner.

DE 10 2012 017 593 A1 discloses a laying head for the automated depositing of blanks of a sheet material on a depositing surface, comprising a storage device for the rotatable storage of a supply roll of wound composite material, a conveying and depositing device, and a draping system for draping supplied composite material onto the depositing surface and removing the carrier material from the draped composite material. The draping system has a plurality of draping rollers arranged next to one another for pressing the composite material onto the depositing surface, and a press force and/or a pivot angle of the individual draping rollers can be individually adjusted.

DE 10 2000 1503 307 A1 describes a composite material composed of a metal layer, an intermediate layer and a fiber-reinforced plastic matrix. In order to improve adhesion between the plastic matrix and the metal layer, the intermediate layer engages in undercuts provided in the metal layer.

US 2022/0176489 A describes a device for producing a metal-composite patch part with a laser oscillator that causes a laser to oscillate; a first laser irradiator is used to perform pattern processing on a surface of a metal with a laser by receiving the laser from the laser oscillator, and a metal-composite adhesive device for adhering a composite tape to the surface of the pattern-processed metal. The device has a supply roller, which supplies a composite tape to the one surface of the pattern-processed metal, and a pressing roller, which presses the composite tape onto the one surface of the metal. Both the connection between the metal and the composite material and productivity can be improved as the number of processes associated with the production process of the metal-composite patch part can be significantly reduced.

### SUMMARY

The invention is based on the problem of improving the connection of fiber composite materials to a metal surface.

The invention solves the problem by way of a method according to the preamble in which the metal surface has a micro-structure with a plurality of micro-recesses, wherein the method comprises the step of applying an oscillating shear force to the fiber composite material, causing matrix material to be introduced into the micro-recesses.

According to a second aspect, the invention solves the problem by way of a fiber composite material laying device for connecting a fiber composite material to a metal surface with (a) an application head for applying the fiber composite material to the metal surface and (b) a consolidation roller for exerting a consolidation force, directed towards the metal surface, on the fiber composite material, wherein (c) the consolidation roller is designed to apply an oscillating shear force on the fiber composite material.

A advantage of the invention is that it does not require an adhesive for connecting the fiber composite material to the metal surface. This reduces the number of boundary surfaces to one, namely the transition from the metal surface to the fiber composite material.

It is also beneficial that, compared to methods known from the prior art, a stronger connection between fiber composite material and metal surface can be achieved.

It can also be advantageous that the increased strength of the connection between the fiber composite material and the metal surface can be achieved with comparatively simple means in terms of equipment.

Within the scope of the present invention, applying the fiber composite material refers in particular to an automatic application. The application of the fiber composite material is understood particularly to mean bringing into contact. Preferably, application refers to a laying or rolling.

The characteristic that the textile is planar is understood particularly to mean that it is not merely a thread. In addition, the planar textile is significantly larger in two spatial direction than in the remaining third direction, namely the dimension of thickness.

The characteristic of applying an oscillating shear force is understood in particular to mean that a periodically oscillating shear force is applied. In particular, the oscillating shear force is applied in order to introduce the matrix material into the micro-recesses. In other words, the shear force is not a by-product of another step in the method, for example a draping.

According to one embodiment, the oscillating shear force is applied in such a way that the shear force has the same force direction at least 50% of the time, especially at least 60% of the time, especially at least 70% of the time, especially at least 80% of the time, especially at least 90% of the time, preferably all of the time, at all points where it is applied to the fiber composite material. Preferably, the force vectors of the shear force always extend in the same direction at the points where the shear force is applied.

According to one embodiment, the application of the oscillating shear force is a continuous application. This is understood to mean that the oscillating shear force is applied in such a way that the surface processed under the oscillating shear force where the fiber composite material is connected to the metal surface constitutes at least 40%, especially at least 50%, especially at least 60%, preferably at least 70%, preferably at least 80%, especially preferably at least 90% of the surface where the metal surface is connected to the fiber composite material.

The fiber composite material is preferably applied to the metal surface by way of a movement along the metal surface. This movement can be performed, for example, by means of a robot. For example, the fiber composite material is applied by means of the application head. According to the invention, this refers in particular to a robot with a fiber composite material laying device. Said device is preferably fixed to an arm of the robot. The robot is preferably configured to guide the fiber composite material laying device, in particular its application head, along the metal surface. The robot preferably has at least two, in particular at least three, preferably at least four, axles.

Exerting the consolidation force directed towards the metal surface is understood particularly to mean that a force is applied to the fiber composite material which is greater in the normal direction to the metal surface in the area of the laying front than in the tangential direction. The laying front is the area where the fiber composite material comes into contact with the metal surface for connecting it to the metal surface. In the present method, the laying front also refers in particular to the area where a material-locking and/or form-fitting connection is formed between the fiber composite material and the metal surface or the component with the metal surface.

The shear force is preferably applied in the longitudinal and/or transverse direction of the fiber composite material. In other words, the shear force is, in particular, not applied in the direction of thickness. In particular, the shear force is thus applied to the fiber composite material at the laying front.

It is beneficial if the consolidation force has a force component in the normal direction of at least 75 Newton, especially at least 100 Newton and/or at most 800 Newton, especially at most 650 Newton, for example at most 500 Newton.

An oscillation frequency of the oscillating shear force is preferably at least 20 Hz, particularly at least 30 Hz. Alternatively or additionally, the oscillation frequency is preferably at most 70 Hz, especially at most 60 Hz, especially preferably at most 50 Hz. A higher frequency requires a more rigid fiber composite material laying device. Higher frequencies are thus possible, but not usually advantageous.

It is beneficial if the oscillating shear force has a shear force amplitude of at least 3 N, especially at least 5 N. The shear force amplitude is preferably at most 50 N, particularly at most 40 Newton, particularly preferably at most 30 N.

Preferably, a slip between the consolidation roller on the one hand and the fiber composite material on the other is at most 1 mm, especially at most 0.5 mm. Particularly preferably, the slip is essentially zero. The characteristic that the slip is essentially zero is understood particularly to mean that the slip is so small that it does not have any noticeable influence on the surface of the fiber composite material facing away from the metal surface. The slip is the maximum distance that a point on the fiber composite material in contact with the consolidation roller moves relative to the adjacent surface of the consolidation roller.

It is beneficial if the consolidation roller has a surface that is at least partially composed of a polymer, particularly a plastic. For example, the consolidation roller has a surface made of polyurethane, silicone or rubber.

Preferably, a static friction coefficient μ between the structuring roller and the fiber composite material is at least μ=0.1 and/or at most μ=0.5.

It is beneficial if the oscillating shear force is applied in such a way that the fiber composite material does not form any folds.

The matrix material can be a thermosetting plastic or a thermoplastic. Generally, it is advantageous if the matrix material contains a thermoplastic or is made of one.

For example, the metal surface may be part of a car part, an aircraft, a ship, a piece of sports equipment or another object or component.

For example, the metal surface is the surface of an object whose metal surface is composed primarily of steel, aluminum or zinc. In particular, the object may be made of an alloy. This alloy is preferably steel or an aluminum alloy.

Preferably, the shear force is exerted at the laying front by means of a consolidation roller, which applies the consolidation force. In other words, the consolidation roller applies both the consolidation force and the shear force on the fiber composite material.

The method preferably comprises the step of introducing a micro-structure into the metal surface by way of irradiation with a laser beam. The laser beam is preferably beamed onto the metal surface at a first angle of incidence. This first angle of incidence is preferably at least 10°; however, a first angle of incidence of at least 60°, especially at least 70°, is particularly beneficial. It is beneficial if the angle of incidence is at most 85°.

The light intensity of the laser is preferably selected in such a way that the material of the metal surface locally melts and/or evaporates. The irradiation creates micro-recesses in the metal surface, which extend along the laser beam and onto the metal surface at an angle of incidence to the normal.

The angle of incidence is measured in the plane along which the fiber composite material is applied.

According to one preferred embodiment, the introduction of the micro-structure into the metal surface comprises the step of irradiating the metal surface with a laser beam at a second angle of incidence. This second work angle is preferably at most 170°, but in particular at most 120°, particularly at most 110°. It is beneficial if the second angle of incidence is at least 95°.

In other words, the micro-structure is preferably created through irradiation from two different directions. The application of the oscillating shear force allows matric material to be introduced into the micro-recesses in the metal surface. If the angle of incidence deviates from the normal direction, as intended according to one preferred embodiment, the matrix material forms interlocking elements in the micro-recesses, which form undercuts. This results in a particularly strong material-locking and form-fitting connection between the metal surface and the fiber composite material.

Alternatively, the micro-structure can be introduced into the metal surface by, for example, a drum, particularly a mandrel drum, wherein the drum preferably points towards the metal surface at an angle of inclination that corresponds to the first or second angle of incidence mentioned above.

Preferably, the micro-recesses are spaced apart from each other in relation to the laying direction by at most 1000 μm, especially at most 500 μm. The distance is preferably at least 25 μm.

A depth of the micro-recesses is preferably at least 20 μm, especially at least 50 μm. The depth is preferably at most 500 μm, especially at most 300 μm.

The shear force preferably oscillates along a laying direction in which the laying front moves. Preferably, the fiber composite material can be laid along a linear path without it resulting in undulations along the laying direction.

However, it is also possible that the shear force oscillates transversely to the laying direction. This, however, may lead to said undulations, which are only desirable in exceptional cases.

According to one preferred embodiment, the method comprises the step of heating the fiber composite material, especially in the area of the laying front. This is achieved, in particular, by means of a heat source. The heat source may refer, for example, to a hot gas fan, a light source or a flame. The light source can be, for example, a laser, especially a diode laser, or a flash lamp. The flame is, for example, a hydrogen flame.

Preferably, the fiber composite material is heated to such a high temperature that the viscosity of the matrix material decreases to the extent that the matrix material penetrates into the micro-recesses due to the oscillating shear force. The matrix material penetrates into at least 50% of the volume of the micro-recesses. This variable is determined by making a cross-section and measuring the area that the matrix material has on the total cross-sectional area of the micro-recesses.

Preferably, the method is carried out using a fiber composite material laying device according to the invention.

The fiber composite material laying device preferably comprises a consolidation roller, which is configured to oscillate in the circumferential direction. Alternatively or additionally, the consolidation roller can be designed to oscillate along a rotational axis of the consolidation roller; this, however, is only advantageous in exceptional cases.

The invention also includes a production device for producing a fiber composite material metal workpiece, in particular a metal workpiece that is reinforced with a fiber composite material, with (a) a fiber composite material laying device according to the invention, (b) a structuring device, particularly a laser structuring device, which is designed to introduce a micro-structure into a metal surface of a component with a metal surface, and (c) a transport device that is configured to transport the component from the structuring device to the fiber composite material laying device, which is designed to produce the fiber composite material metal workpiece by applying a fiber composite material onto the component.

The structuring device is preferably configured to introduce a micro-structure into the metal surface by way of irradiation with a laser beam. Preferably, the structuring device is designed to automatically irradiate the metal surface with a laser beam at the first angle of incidence mentioned above and at the second angle of incidence mentioned above. This results in a metal surface that is structured in two directions.

### DESCRIPTION OF THE DRAWINGS

In the following, the invention will be explained in more detail with the aid of the accompanying drawings. They show:

FIG. 1a a perspective view of a fiber composite material laying device according to the invention,

FIG. 1b a schematic cross-section through the consolidation roller and the component,

FIG. 2a a schematic, perspective view of a part of the fiber composite material laying device with a heat source,

FIG. 2b a schematic view of the consolidation roller for generating the oscillating shear force, and

FIG. 3 schematically depicts a production device according to the invention that has a structuring device.

### DETAILED DESCRIPTION

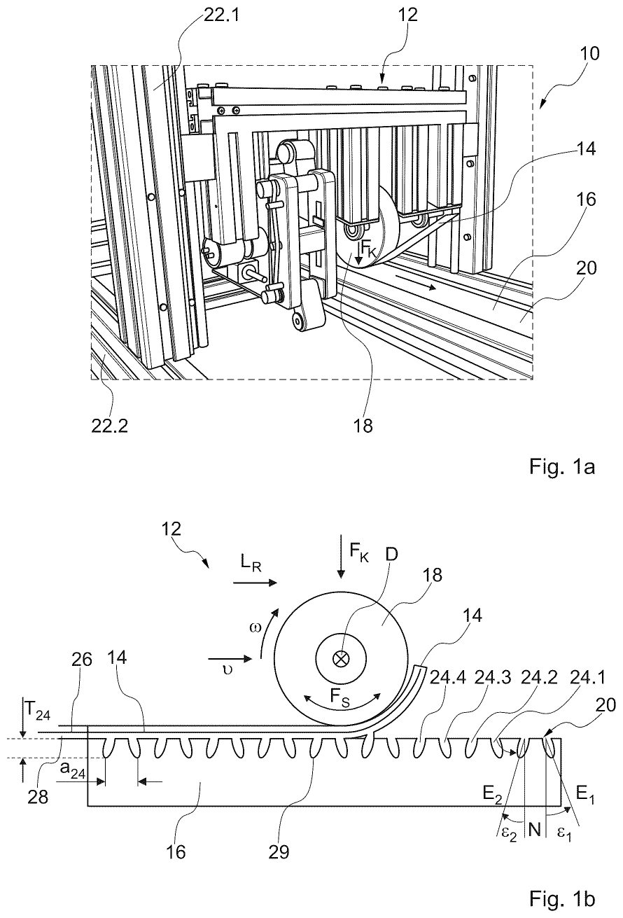

FIG. 1a depicts a fiber composite material laying device 10 according to the invention that comprises an application head 12 for applying a fiber composite material 14 to a component 16. The application head 12 comprises a consolidation roller 18 for exerting a consolidation force F_{K} acting on a metal surface 20 of the component 16 onto the fiber composite material 14.

The application head 12 is designed to apply the fiber composite material 14 in a laying direction L_{R}. As demonstrated in FIG. 1a, the application head 12 can be guided on at least one guide 22.1, 22.2. In the present case, the guides 22.1, 22.2 are designed as a gantry. However, it is also possible that the application head 12 is guided along the metal surface 20 by a robot, which preferably has at least two axes.

FIG. 1b schematically depicts a cross-section through the consolidation roller 18, which rotates about an axis of rotation D. It illustrates that the component 16 has a micro-structure in its metal surface 20 that comprises a plurality of micro-recesses 24.i (i=1,2, . . . ).

The fiber composite material 14 is composed of a schematically depicted textile 26 in a matrix 28 made of matrix material 29. For example, the matrix material is a thermoplastic resin.

The consolidation roller 18 performs a largely constant rotational movement with an angular velocity ω₁₈. The fiber composite material 14 comes into contact with the metal surface 14 at a laying front 30 and is pressed by the consolidation roller 18 onto the metal surface 20. The consolidation roller 18 applies a shear force F_{S}, which oscillates, in the area of the laying front 30. For example, the shear force F_{S}(t)=F_{S,O}*sin(2πf_{S}t) with a shear force amplitude F_{S,O} and an oscillation frequency f_{S}.

By applying the oscillating shear force F_{S}(t), part of the matrix material 29 is pressed into the micro-recesses 24.i. This results in a strong, form-fitting and material-locking connection between the fiber composite material 14 and the metal surface 20. The consolidation roller 18 and thus particularly the application head 12 move forwards at a laying speed v.

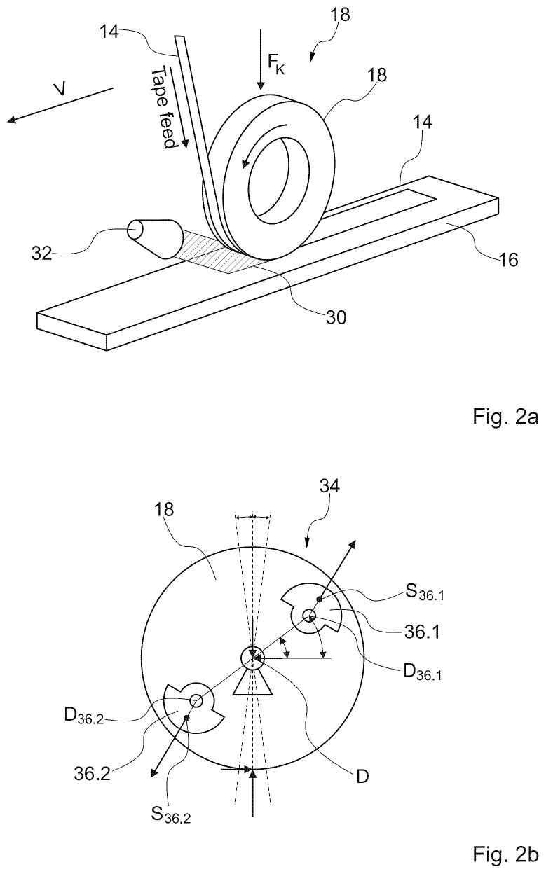

FIG. 2a shows a perspective view of the consolidation roller 18 and a heat source 32 is depicted. The heat source 32 is arranged to heat the fiber composite material 14 in the area of the laying front 30. In particular, the heat source 32 is designed to heat the fiber composite material 14 exclusively in the area of the laying front 30. The heat source 32 may be, for example, a diode laser.

The fiber composite material laying device 10 has a shear force generator 34 which, as shown in FIG. 2b, can be arranged on the consolidation roller 18. The shear force generator 34 comprises a first eccentric 36.1 and a second eccentric 36.2. Each eccentric is rotatably mounted about a respective axis of rotation D_{36.1}, D_{36.2}. The axis of rotation D of the consolidation roller lies on a straight line G with the axes of rotation D_{36.1}, D_{36.2}. It is also advantageous if, as in the present case, the distances between the axes of rotation D_{36.1}, D_{36.2} and the axis of rotation are the same. The eccentrics 36.1, 36.2 are driven by a motor, not depicted here.

The eccentric 36.1 has a first center of mass m_{36.1}; the eccentric 36.2 has a second center of mass m_{36.2}. The eccentrics 36.1, 36.2 are driven in such a way that the second center of mass m_{36.2} lies precisely on the straight line G when the first center of mass m_{36.1} also lies on the straight line G. This results in a periodically fluctuating torque M₁₈, which acts on the consolidation roller 18. This effects the periodically fluctuating shear force F_{S}.

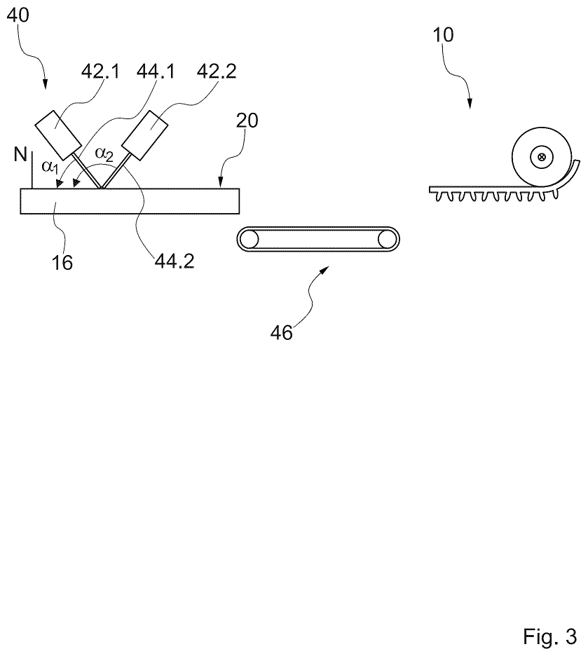

FIG. 3 schematically depicts a production device 38 according to the invention that has a structuring device 40. The structuring device 40 may comprise one or two (or more) lasers 42.1, 42.2, each of which irradiates the metal surface 20 with a laser beam 44.1, 44.2 in such a way that results in the micro-recesses 24.i (compare FIG. 1b). The components 16 machined in this manner are transported to the fiber composite material laying device 10 by means of a conveying installation 46. The conveying installation can be a transport belt, a robot or a vehicle, such as a floor-mounted conveyor.

The first laser beam 44.1 strikes the metal surface 20 at a first angle of incidence α₁. The second laser beam 44.2 strikes the metal surface 20 at a second angle of incidence α₂. The two angles of incidence can be equal in absolute values in relation to a normal N on the metal surface 20. This results in micro-recesses 24.i.

The recesses 24.1, 24.3, 24.5, . . . created by the first laser beam 44.1 have a direction of extension E₁ (see FIG. 1b) that extends onto the metal surface 20 at a first angle of extension ε₁ to the normal N. The recesses 24.2, 24.4, 24.6, . . . created by the second laser beam 44.2 have a direction of extension E₂ that extends at a first angle of extension ε₂ to the normal N onto the metal surface 20. The two angles of extension can be equal in absolute value. However, in terms of the plane that is perpendicular to the axis of rotation D, they extend away from the normal N in different directions.

In terms of the laying direction L_{R}, the micro-recesses 24.i are at a distance a₂₄ from one another. For example, 25 μm≤a₂₄≤500 μm.

On average, the micro-recesses 24.i have a depth t₂₄ of, for example, 25 μm≤t₂₄≤500 μm.

### REFERENCE LIST

10 fiber composite material laying device
12 application head
14 fiber composite material
16 component
18 consolidation roller
20 metal surface
22 guide
24 micro-recesses
26 textile
28 matrix
29 matrix material
30 laying front
32 heat source
34 shear force generator
36 eccentric
38 production device
40 structuring device
42 laser
44 laser beam
46 conveying installation
α angle of incidence
ε angle of extension
ω₁₈ angular velocity
a₂₄ distance between micro-recesses
D axis of rotation
E direction of extension
F_{K} consolidation force
F_{S} shear force
F_{S,O} shear force amplitude
G straight line
i running index
m₃₆ center of mass
M₁₈ torque
N normal
L_{R} laying direction
T₂₄ micro-recess depth
v laying speed

1. A method for connecting a fiber composite material to a metal surface of a component, comprising:
applying the fiber composite material to the metal surface, wherein said fiber composite material comprises a planar textile and a matrix that is made of a matrix material and embeds the planar textile, and wherein the metal surface comprises a micro-structure with a plurality of micro-recesses,
exerting a consolidation force directed towards the metal surface onto the fiber composite material, and
applying an oscillating shear force to the fiber composite material sufficient to cause the matrix material of the fiber composite material to be introduced into the micro-recesses of the metal surface.

2. The method according to claim 1, wherein the oscillating shear force (Fₛ) is applied at a laying front where the fiber composite material comes into contact with the metal surface, and/or
the shear force is applied by a consolidation roller so as to exert the consolidation force.

3. The method according to claim 1, further comprising:
introducing the micro-structure into the metal surface by irradiation of the metal surface with a laser beam,
wherein, during the introducing step, the laser beam strikes the metal surface at a first angle of incidence (α) and
wherein the laser beam strikes the metal surface at a second angle of incidence which is different from the first angle of incidence.

4. The method according to claim 1, wherein the shear force (Fₛ) oscillates along a laying direction in which a laying front moves, and/or transversely to the laying direction.

5. The method according to claim 1, further heating the fiber composite material.

6. A fiber composite material laying device for connecting a fiber composite material to a metal surface, comprising:
an application head for applying the fiber composite material to the metal surface,) and
a consolidation roller for exerting a consolidation force (directed towards the metal surface onto the fiber composite material,
wherein the consolidation roller is designed to apply an oscillating shear force to the fiber composite material.

7. The fiber composite material laying device according to claim 6, wherein the consolidation roller is designed
to oscillate in a circumferential direction, and/or
to oscillate along an axis of rotation of the consolidation roller.

8. A production device for producing a fiber composite material workpiece, comprising:
a fiber composite material laying device according to claim 6,
a structuring device configured to introduce a micro-structure into a metal surface of a component, and
a transport device arranged to transport the component from the structuring device to the fiber composite material laying device.

9. The production device according to claim 8, wherein
the structuring device is configured to introduce a micro-structure into the metal surface of the component by irradiation with a laser beam.

10. The production device according to claim 9, wherein
the structuring device is configured to automatically irradiate the metal surface with a laser beam at a first angle of incidence and at a second angle of incidence that is different to the first angle of incidence.
